(19) United States
(12) Patent Application Publication
(10) Pub. No.: US 2006/0174478 A1
(43) Pub. Date: Aug. 10, 2006

(54) Apparatus for disposing capillary structure into heat pipe

(75) Inventor: Hul-Chun Hsu, Taichung City (TW)

Correspondence Address: HDSL, 4331 STEVENS BATTLE LANE, FAIRFAX, VA, 22033, US

(73) Assignee: JAFFE LIMITED

(21) Appl. No.: 11/302,279

(22) Filed: Dec. 14, 2005

(30) Foreign Application Priority Data
Feb. 4, 2005 (TW) 094202300

(51) Int. Cl. B23P 15/26; B23P 6/00

(52) U.S. Cl. 29/726; 29/890.032

(57) ABSTRACT

An apparatus for disposing a multi-layered capillary structure into a heat pipe. The apparatus drags a multi-layered interwoven web into a heat pipe body, so as to form a capillary structure of multi-layered interwoven web in the heat pipe body. The apparatus includes a base, a towing mechanism, an affixation mechanism, a cutting mechanism and a set of web support. The base defines a working path, which is a fictitious path that the multi-layered interwoven web travels for penetrating through the heat pipe body. A plurality of delivery wheels is disposed at the starting point of the working path. The web support includes a plurality of supporting blocks, each corresponding to a delivery wheel.

### BACKGROUND OF THE INVENTION

The present invention relates generally to an apparatus for disposing a plurality of capillary structures into a heat pipe, and more particularly to an apparatus that employs a pull rod to drag an interwoven web passing through a heat pipe body, so as to continuously dispose a plurality of capillary structures into the heat pipe.

One application of pull rod to dispose an interwoven web into a heat pipe body is disclosed in the Taiwanese Published Patent No. 593960, entitled “Method for disposing capillary structure in heat pipe and the apparatus thereof.” The published patent teaches a method for disposing a single layer interwoven web into a heat pipe body. By properly control the interwoven web, it can be dragged into the heat pipe body by using a pull rod. However, a capillary structure composed of a multiple of interwoven webs is often used to enhance the capillary effect of the capillary structure. Since normal interwoven webs are made of soft materials, it is very difficult to regularly dispose them into the heat pipe body layer by layer. Thus, it is difficult to produce heat pipes with multi-layered capillary structures in mass production.

Accordingly, the inventor of the present invention realized the drawbacks in the conventional art, and developed the present invention that can overcome the drawbacks described above.

### BRIEF SUMMARY OF THE INVENTION

The present invention is to provide an apparatus for disposing a multi-layered capillary structure into a heat pipe. By controlling the multi-layered interwoven web to sequentially curve according to the inner radius of the heat pipe body, so as to continuously drag the interwoven web penetrating the heat pipe body via a pull rod. Therefore, the fabrication of heat pipes having multi-layered capillary structure become much easier than in the conventional art.

In order to achieve the above and other objectives, the present invention provides an apparatus for disposing a multi-layered capillary structure into a heat pipe. The apparatus drags a multi-layered interwoven web into a heat pipe body, so as to form a capillary structure of multi-layered interwoven web in the heat pipe body. The apparatus includes a base, a towing mechanism, an affixation mechanism, a cutting mechanism and a set of web support. The base defines a working path, which is a fictitious path that the multi-layered interwoven web travels for penetrating through the heat pipe body. A plurality of delivery wheels is disposed at the starting point of the working path. The web support includes a plurality of supporting blocks, each corresponding to a delivery wheel.

### BRIEF DESCRIPTION OF THE DRAWINGS

FIG. 1 illustrates a heat pipe body of the present invention before a capillary structure is disposed therein.

FIG. 2 illustrates a heat pipe body of the present invention after a capillary structure is disposed therein.

FIG. 3 is a sectional view along line 3-3 of FIG. 2.

FIG. 4 is a sectional view along line 4-4 of FIG. 2.

FIG. 5 is a sectional view illustrating the heat pipe body of the present invention after a plurality of interwoven webs is disposed therein.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

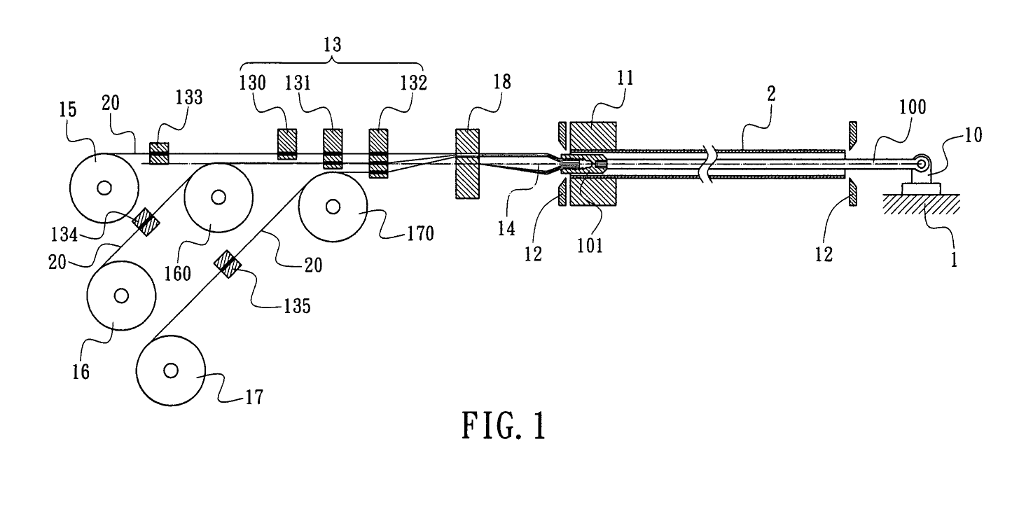

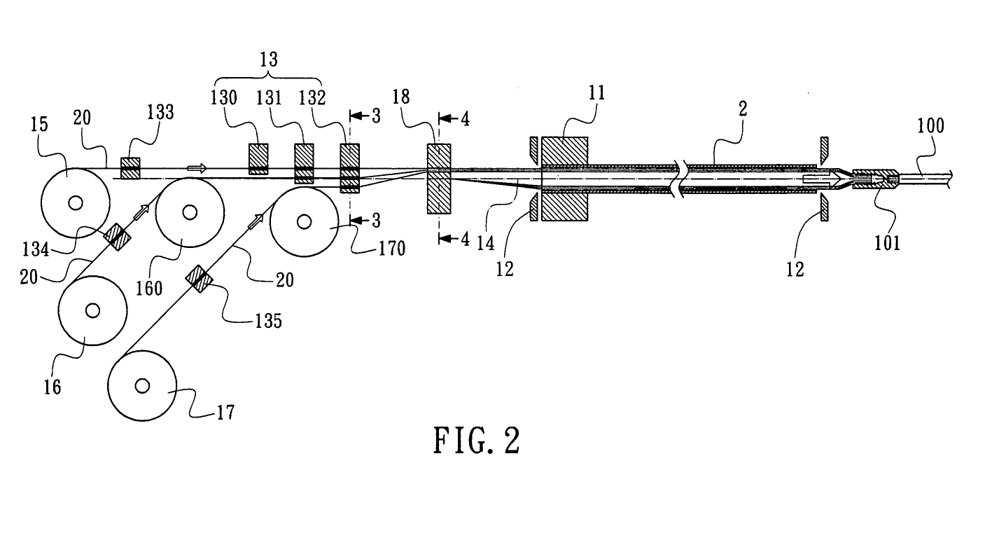

Referring to FIG. 1 and FIG. 2, a heat pipe body of the present invention before and after a capillary structure is disposed therein are illustrated, respectively. As shown, the present invention provides an apparatus for disposing a capillary structure into a heat pipe, which disposes a multi-layered interwoven web 20 into a heat pipe body 2, such that the heat pipe body 2 includes a capillary structure of a multi-layered interwoven web 20 (as shown in FIG. 5). The apparatus includes a base 1, a towing mechanism 10, an affixation mechanism 11, a cutting mechanism 12 and a set of web supports 13.

The base 1 is a supporting main body for supporting all the component parts of the apparatus. A working path 14 is defined above the base 1. The working path 14 is the fictitious path that the multi-layered interwoven web 20 travels for being disposed into the heat pipe body 2.

The towing mechanism 10 is disposed on the base 1 and can move along the ending point of the working path 14. The towing mechanism 10 includes a pull rod 100. The pull rod 100 is extended from the starting point of the working path 14 and penetrates through the heat pipe body 1. The other end of the pull rod 100 includes a towing portion 101 formed thereon. The towing portion 101 can be a clamping assembly for clamping one end of the interwoven web 20. The towing portion 101 is then moved on the ending point of the working path 14 by employing the towing mechanism 10 to drive the pull rod 100. Meanwhile, the multi-layered interwoven web 20 is disposed in the heat pipe body 2.

The affixation mechanism is located on the working path 14 and is used to fasten the heat pipe body 2, so as to securely position the heat pipe body 2 on the working path 14. The towing mechanism 10 can then exert a force to drag the pull rod 100 into the heat pipe 2, thereby disposing the multi-layered interwoven web 20 into the heat pipe body 2.

The cutting mechanism 12 is located on the working path 14 and is located corresponding to the two ending portions of the heat pipe body 2. The cutting mechanism 12 cuts the multi-layered interwoven web 20 at the two ending portions of the heat pipe body 2, once the multi-layered interwoven web 20 is disposed in the heat pipe body 2. The heat pipe having the multi-layered interwoven web 20 disposed therein is then taken off the working path, thereby completing the fabrication of the heat pipe.

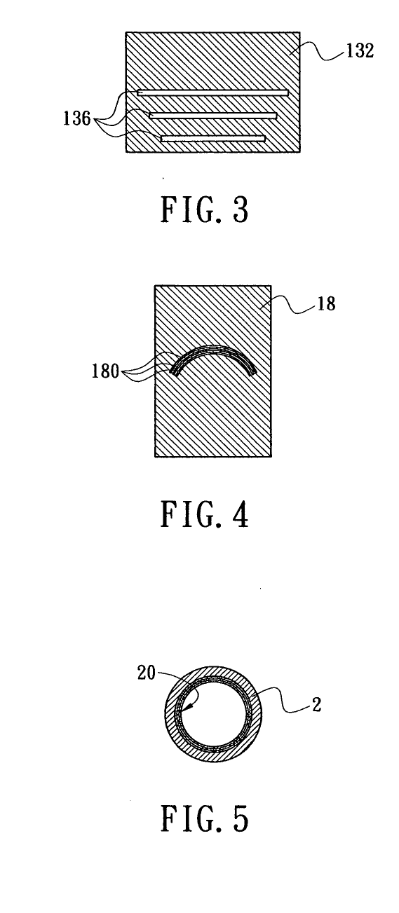

The feature of the present invention is in that a set of web supports 13 is disposed between the starting point of the working path 14 and the heat pipe body 2. The web supports 13 aligns, sorts and stacks the multi-layered interwoven web 20. The web supports 13 includes a plurality of supporting block 130, 131, 132, each supporting block 130, 131, 132 having a hole 136 for the interwoven web 20 the penetrate therethrough (as shown in FIG. 3). The shape of the cross section of the hole 136 can be a thin rectangle. The number of the hole 136 depends on the number of capillary structure layers to be disposed, and the sequence that the interwoven web 20 penetrates the supporting block 130, 131, 132. In this particular embodiment, the supporting blocks are the first supporting block 130, the second supporting block 131, and the third supporting block 132. A plurality of delivery wheels 15, 16, 17 is disposed extending from the starting point of the working path 14. Each delivery wheel 15, 16, 17 corresponds the first, the second and the third supporting block 130, 131, 132. Namely, the first, the second and the third supporting blocks 130, 131, 132 are located between the heat pipe body 2 and the delivery wheels 15, 16, 17, respectively. Each delivery wheel 15, 16, 17 is used to collect the interwoven web 20. The interwoven web 20 on each of the delivery wheel 15, 16, 17 penetrates sequentially the first, the second and the third supporting block 130, 131, 132. The head portion of the interwoven web 20 is the clamped by the towing portion 101. In this manner, the interwoven web 20 made of soft materials can be dragged into the heat pipe body 2 sequentially, so as to continuously dispose the multi-layered capillary structure into the heat pipe.

Therefore, an idle wheel 160, 170 can also be disposed between the delivery wheels 16, 17, and the first and the second supporting blocks 131, 132 for aiding the delivery of the interwoven web 20. When the distance between each delivery wheel 15, 16, 17 and each supporting block 130, 131, 132 is lengthened, a tension adjustment mechanism 133, 134, 135 can be added to provide extensive support for longer path of transportation.

Referring further to FIG. 4, the apparatus can further include a patterned web support 18. The patterned web support 18 includes a plurality of holes 180, the cross section of which is in an arc-shape. The holes 180 can form the interwoven web 20 into a curved shape before being disposed in the heat pipe body 2. The interwoven web 20 can be further curved to fit the opening of the heat pipe body 2. The patterned web support 18 can also be composed of one or more blocks. The curved hole of each block gradually converges to the shape of the inner radius of the heat pipe body 2. The patterned web support 18 is disposed on the working path 14 between the web support 13 and the heat pipe body 2.

Accordingly, an apparatus for disposing a multi-layered capillary structure into a heat pipe is obtained.

Therefore, the apparatus for disposing a multi-layered capillary structure into a heat pipe of the present invention can sequentially drag the curved soft interwoven web 20 into the heat pipe body 2 via the web support 13, thereby fabricating heat pipes having multi-layered capillary structures.

In summary, the apparatus and method of the present invention can indeed satisfy the patentability requirements of the patent law, a grant of letters patent is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. An apparatus for disposing a multi-layered capillary structure into a heat pipe, comprising:
a base, which defines a working path thereon;
a towing mechanism movable along the ending point of the working path, one end of the towing mechanism being connected to one end of a pull rod, the pull rod being extended from the starting point of the working path, the other end of the towing mechanism having a towing portion formed thereon;
an affixation mechanism located on the working path for fastening thereon a heat pipe body;
a cutting mechanism located on the working path corresponding to the end portions of the heat pipe body; and
a web support located between the starting point of the working path and the heat pipe body; wherein
a plurality of delivery wheels is disposed on the working path, and the web support further comprises a plurality of supporting blocks, each delivery wheel corresponding to one supporting block.

2. The apparatus as recited in claim 1, wherein the towing portion comprises a clamping assembly.

3. The apparatus as recited in claim 1, wherein an idle wheel is disposed between each delivery wheel and each supporting block.

4. The apparatus as recited in claim 1, wherein a tension adjustment mechanism is disposed between each delivery wheel and each supporting block.

5. The apparatus as recited in claim 1, wherein the supporting block comprises a hole of a thin rectangular shape.

6. The apparatus as recited in claim 1, further comprising a patterned web support disposed on the working path, which is located between the web support and the heat pipe body.

7. The apparatus as recited in claim 6, wherein the patterned web support comprises a hole of an arc-shape.

8. The apparatus as recited in claim 7, wherein the patterned web support comprises a plurality of blocks, the arc-shaped hole of each block converging to the shape of the inner radius of the heat pipe body.
